(19) United States
(12) Patent Application Publication
(10) Pub. No.: US 2008/0187890 A1
(43) Pub. Date: Aug. 7, 2008

(54) WORD-BUILDING BOARD GAME

(76) Inventor: Lori M. Podurgiel, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/024,321

(22) Filed: Feb. 1, 2008

Related U.S. Application Data
(60) Provisional application No. 60/899,156, filed on Feb. 2, 2007.

(51) Int. Cl. G09B 19/22; A63F 3/00; A63F 1/00

(52) U.S. Cl. 434/129; 273/272; 273/299

(57) ABSTRACT

A board game for enhancing spelling and word-forming skills that can be played by multiple players and enjoyed by people of all ages. The game comprises a playing board and a set of cards that have a set of characters, such as letters, on one side. To play, one or more cards are selected and each player attempts to form as many words containing the displayed letters as he or she can in the allotted time. Points are awarded based at least in part on the number of words formed. The game is won when a player earns enough points to move his or her playing piece from the START position to the FINISH position.

### CROSS REFERENCE TO RELATED APPLICATIONS

This application claims the benefit of U.S. Provisional Patent Application No. 60/899,156 filed Feb. 2, 2007, and entitled “Word-building Board Game,” the contents of which are incorporated herein by reference.

### BACKGROUND OF THE INVENTION

1. Field of the Invention

A board game wherein players score points by forming words from given letters is provided More specifically, players attempt to be the first to score a set number of points by selecting a card or cards, each displaying a plurality of letters and forming words containing some or all of the letters displayed on the card(s). Also described is a method of playing the board game.

2. Description of the Prior Art

Many board games have been developed in the past premised on the idea of requiring players to score points by spelling and/or building words. Such games are popular for players of all ages as they are a fun way of developing and enhancing vocabulary and spelling skills.

One example of such a game is disclosed by Mansfield in U.S. Pat. No. 1,034,633. Mansfield discloses a game where players roll a set of five dice, where each die displays a different letter on each face. The player then attempts to form a word using at least one of the letters displayed and moves one space on the playing board for each of the displayed letters used in forming the word.

Another example of a word-forming game is disclosed by Gates in U.S. Pat. No. 5,145,183. Gates discloses a game where a card with a word printed thereon, known as the baseword, is selected and placed so that all players can see it. Each player then simultaneously tries to form as many words as he or she can from the letters contained in the baseword. At the end of the allotted time, the lists of formed words are compared and each player receives points for any words he or she created that were not also created by another player.

### SUMMARY OF THE INVENTION

One object of the instant invention is to provide a board game that combines word-building and spelling skills, good fortune, and strategy to produce an entertaining and educational game that will retain the interest of several players for an extended period of time. The players are given a set of letters and are required to individually create words that include all of the given letters as well as any additional letters the players may wish to use. Points are awarded based on the number of words formed. In one embodiment, points are only awarded if the word created is not also created by any other player. Additional points may be awarded if the given letters appear in the created word in the same order that they are presented on the card.

Another object of the instant invention is to provide a decorative playing surface and game pieces that produce an aesthetically pleasing board game.

Another object is to provide a board game comprising a board, playing pieces, and a deck of cards marked with letters and/or symbols. The components, when not in use, can be stored in a decorative box with the tradename SCRATCH YOUR HEAD displayed thereon.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a top view of a game board and other components used to play the game.

FIG. 2 is a top view of an embodiment of a card used to play the game.

FIG. 3 is a top view of another embodiment of a card used to play the game.

### DETAILED DESCRIPTION OF THE INVENTION

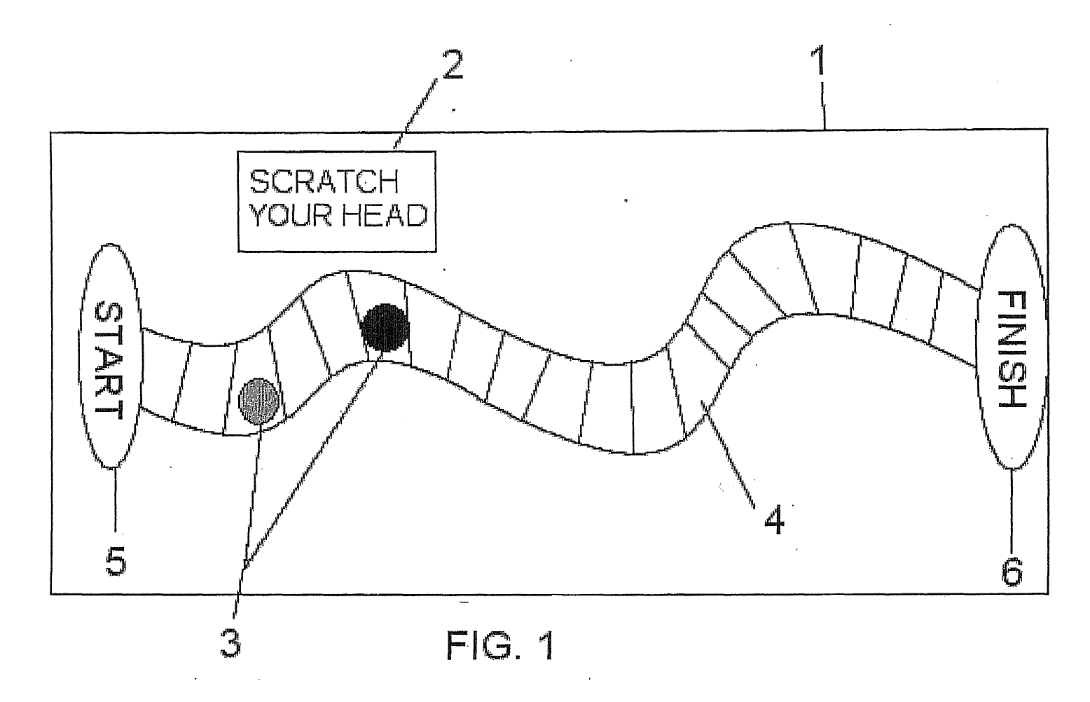

As used herein, spatial or directional terms, such as “left”, “right”, “inner”, “outer”, “above”, “below”, “top”, “bottom”, and the like, relate to the invention as it is shown in FIGS. 1-3. However, it is to be understood that the invention may assume various alternative orientations and, accordingly, such terms are not to be considered as limiting.

A word-building board game that challenges a group of players to form as many words from a given set of letters as they can in a predetermined amount of time is provided. The game can be played by any number of players and can be enjoyed by persons of all ages. The object of the game is to accumulate, or earn, a sufficient amount of points to win the game. Points may be awarded based on, among other factors, the number, uniqueness, and length of the words formed. The amount of points earned by a player is reflected by the position of the player's playing piece on the game board.

Referring to FIGS. 1-3, the board game of the instant invention is comprised of a playing board and a plurality of cards. The game is to be played on a flat surface, such as a table or on the floor.

The board 1 includes a number of distinct blocks or spaces 4 which are arranged in a row or chain with at least one edge of each block located near or abutting the edge of another block. The blocks 4 are arranged between a START position 5 and a FINISH position 6 so as to form a path or trail which extends between the START and FINISH positions 5, 6. In one embodiment, each block 4 symbolizes a specific increment or amount of points that have been earned by a player during the course of the game. For example, each block 4 may represent a 25-point increment. In this embodiment, the location of a player's playing piece 3 indicates how many points that player has accumulated since the game began. For instance, if each of the blocks 4 represents a 25-point increment, a player with his playing piece 3 located within the fifth block from the START position 5, so that there are four blocks between the current block and the START position 5, the player has earned between 101 and 125 points.

Staying with the same example, once the player has earned 126 or more points, his playing piece will be moved to a subsequent block. The amount of points represented by each of the blocks 4 may also vary so that, for example, the first block represents an accumulated point total of between 1 and 10 points while the second block represents an accumulated point total of between 11 and 35 points. In another embodiment, instead of representing the number of points accumulated by a player, each block 4 represents another value, such as the total number of words formed by a player or the difference between the number of words formed by one player and the number of words formed by another player.

At the start of the game, each playing piece 3 is placed at the START position 5. The game ends when a player has earned enough points so that his playing piece 3 has advanced from the START position 5 to the FINISH position 6. In one embodiment, the FINISH position 6 is reached when a player earns 2,000 total points. Of course, other point totals can also be used. The START and FINISH positions, 5, 6, as well as the other blocks 4, may remain unmarked or contain an indication of the point value associated therewith, among other possibilities.

The game of the instant invention also comprises a plurality of cards 2. Each card 2 has two sides. The first side primarily contains an ornamental design which is the same on each card 2. By incorporating the same ornamental design on the first side of each card, the players cannot distinguish between the cards when the ornamental design side is facing the players. This ornamental design may incorporate the tradename “SCRATCH YOUR HEAD” therein.

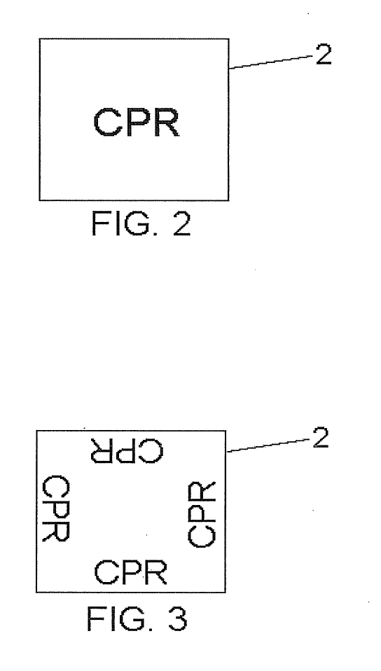

The second side of each card 2 contains at least one letter or symbol, jointly referred to herein as “characters”, printed thereon. The letters may be from the alphabet of any language, such as English or Spanish. In one embodiment, the second side of the card 2 includes a single letter or symbol. In another embodiment, shown in FIGS. 2-3, the second side of the card 2 contains a plurality of characters, such as three letters or two letters and one symbol. If more than one character appears on the card, the characters may be displayed as a set, meaning that they are arranged in close proximity to one another with the same spatial orientation, as shown in FIGS. 2-3.

Each character, or if there is more than one character on a card, each set of characters, can appear at any position on the surface of the card 2. In one embodiment, shown in FIG. 2, the character or set of characters appears at the center of the card surface. In another embodiment, shown in FIG. 3, an identical character or set of characters appears once on each of the four edges of the card 2. In this latter embodiment, players sitting at various positions around the board 1 can clearly see what characters are displayed on the card 2 when the card 2 is placed flat on the board 1. Obviously, other arrangements are also possible. Some of the cards 2 may contain a symbol indicating that the card 2 is a special or “bonus” card entitling the players to certain advantages, described below.

The game also includes a playing piece 3 for each player or team. Such paying pieces 3 are commonly known by those skilled in the art and are used in many other board games. The playing pieces 3 may be of any shape, size, and color, only limited in size and shape by the constraints of the board 1 and the blocks 4 therein. The playing pieces 3 should be distinguishable from one another.

The present invention will be further exemplified through the following discussion, which provides non-limiting examples of methods of playing the board game.

At the start of the game, one player selects at least one card from the deck. If each card contains only one letter, the player must select multiple cards, such as three, or whatever number the rules dictate. If each card contains multiple letters, the game can be played with the player selecting only one card. The card or cards 2 are then placed with the character-containing side facing up, or away from the board 1, and positioned so that all of the players can see the characters. Each player then attempts to form as many words as he or she can in the predetermined allotted time period which contain the letters. In one embodiment, all of the displayed letters must be used to form an individual word. For example, if the displayed letters are “C-P-R”, a player could form the words “COPPER” and “PRICE”, each of which contains all three of the displayed letters. While the previous example involved the use of three letters, one skilled in the art would clearly understand that the game could be played using more or less letters in a similar manner. It is also possible that the player need only use a certain number of the displayed letters in forming words. As an example, if the card displayed five characters, such as “S-B-T-L-E”, each player could be awarded a certain number of points for forming a word using two of the letters, such as “SIT”, with additional points being awarded for forming a word like “STABLE” where all of the letters are used.

As mentioned above, the cards may contain symbols in addition to letters. Different symbols can be used for various purposes. One symbol may be used to represent that the card is a bonus card, as described below. Another symbol, displayed in place of a letter, may be used to represent a plurality of letters, such as all vowels or all consonants. For example, if the displayed characters are “C-*-R”, where “*” has been defined to represent all vowels, the players can earn points for creating words which contain the letters “C”, “R”, and any of the vowels in the manner described above.

In one embodiment, the predetermined allotted time period is three minutes. The allotted time can be measured by any sort of timer known in the art. Other time periods can also be used.

The methods of determining the points earned will now be described. In one embodiment, each player earns a set number of points for each word created. For example, if a player forms ten words in the allotted time, the player receives ten points, or some multiple of ten. In another embodiment, the number of points awarded for each word formed is based at least in part on the uniqueness of the word so that less or even no points are awarded for a word that was formed by more than one player. For example, after the allotted time period has expired, the players read aloud the words they have formed. If any word is formed by more than one player, no points are awarded for that word. If a word is formed by only one player, that player is awarded a certain amount of points for that word, such as 25. In another embodiment, additional points are awarded for words formed from the letters on the card if the card has a symbol indicating that it is a “bonus” card.

For example, if the card is marked as a “bonus” card, each word formed from the letters on the card may result in the player being awarded twice as many points as is normally awarded for each word. These scoring methods described above only represent some of the possibilities for determining the points earned by a player. One skilled in the art would understand that additional methods could be used, as well as combinations thereof.

Each player may also earn additional points for forming words which contain the letters in the same order they are presented on the card. If the card contains a set of three letters, this “presented order” is the order the letters appear on the card as read from left to right. If the card contains one letter, the “presented order” may be determined by either the order in which the cards are selected or an arrangement chosen by a player after all of the cards have been selected. For example, if the presented order of the letters is “C-P-R”, the word “COPPER” would be worth more points that the word “PRICE” because “COPPER” uses the letters “C-P-R” in the presented order while the word “PRICE” does not. In one embodiment, for example, a player earns 50 points for creating a word that uses the letters in the presented order but only 25 points for forming a word that uses the letters in an order other than the presented order.

After the allotted time for a particular round of play expires, each player determines the amount of points he or she has earned, as previously discussed, and these points are added to the player's total cumulative points. After the points are totaled, each player moves his or her playing piece 3 to the block on the game board 1 that corresponds to the number of cumulative points earned. The next card or cards 2 are then selected, the timer is reset, and the players begin a new round.

The game continues until one player has earned enough points to move his or her playing piece into the area labeled “FINISH”. In one embodiment, this corresponds to a value of 2,000 total cumulative points earned by any one player. At this point the game is over unless the remaining players elect to continue playing to determine second place, third place, and so on.

Additionally, although the present invention is described using a physical game board, the present invention may also be played as a computer game.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A game for enhancing the spelling and vocabulary skills of several players, said game comprising a plurality of cards consisting of two sides where a first side comprises an ornamental design and a second side comprises a plurality of characters, at least one of which is a letter, wherein one of said cards is selected and each player attempts to earn points by forming words comprising the letters displayed on the selected card as well as additional letters.

2. The game of claim 1, wherein the second side of at least one of the cards further comprises a symbol indicating that the card is a bonus card entitling the player to earn additional points for each of the words formed.

3. The game of claim 1, further comprising a timing device.

4. The game of claim 1, further comprising a game board including a start position, a finish position, and a path extending between said start and finish positions, wherein said path is divided into distinct spaces.

5. The game of claim 1, wherein the words formed comprise the letters displayed on the selected card in the same order the letters are displayed on the card.

6. A game for enhancing the spelling and vocabulary skills of several players, said game comprising a plurality of cards consisting of two sides where a first side comprises an ornamental design and a second side comprises a single letter, wherein a plurality of said cards are selected and each player attempts to earn points by forming words containing all of the letters displayed on the second side of the selected cards as well as additional letters.

7. The game of claim 6, further comprising a game board including a start position, a finish position, and a path extending between said start and finish positions, wherein said path is divided into distinct spaces.

8. A method of playing a game, comprising the steps of:
a) providing a plurality of cards consisting of two sides where a first side comprises an ornamental design and a second side comprises a plurality of characters, at least one of which is a letter;
b) providing at least one playing piece for each player;
c) selecting at least one of said cards;
d) forming words which comprise at least some of the letters on the card or cards selected in step (c);
e) earning points based at least in part on the number of words formed in step (d);
f) moving said playing piece to reflect the points earned in step (e);
g) repeating steps (c) through (f); and
h) finishing the game when any of said playing pieces is in a predetermined finish position.

9. The method of claim 8, wherein the second side of said cards contains three characters, and only one card is selected in step (c).

10. The method of claim 9, wherein all three characters are letters.

11. The method of claim 8, wherein each word formed in step (d) comprises all of the letters on the card or cards selected in step (d).

12. The method of claim 11, wherein each word formed in step (d) comprises the letters on the card or cards in the same order the letters are displayed on the card or cards.

13. The method of claim 10, wherein each word formed in step (d) comprises all of the letters on the card selected in step (c).

14. The method of claim 13, wherein each word formed in step (d) comprises all of the letters on the card in the same order the letters are displayed on the card.

15. The method of claim 8, wherein at least one of the steps are performed on a computer.

16. The method of claim 8, further comprising the step of providing a game board including a start position, a finish position, and a path extending between said start and finish positions, wherein said path is divided into distinct spaces.
